(19) United States
(12) Patent Application Publication
(10) Pub. No.: US 2007/0198935 A1
(43) Pub. Date: Aug. 23, 2007

(54) Visual document navigation scheme

(75) Inventors: Larry L. Constantine, Rowley, MA (US); Jeannine A. Strope, Longmont, CO (US); David Andrew Williams, Minneapolis, MN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Information Solutions LLC

(21) Appl. No.: 11/359,009

(22) Filed: Feb. 22, 2006

(51) Int. Cl. G06F 3/00

(52) U.S. Cl. 715/744

(57) ABSTRACT

A visual document navigation scheme displays items and their related data in a vertically aligned manner using horizontal indentations to visually link an item and its related data. A document navigator software produces such a display to facilitate accurate document viewing and efficient document navigation in a fast-paced, multi-tasking environment (e.g., a nurse or clinician on duty in a hospital). The use of vertically-aligned positional markers by the document navigator program to place an item and its related data at substantially the same horizontal starting location on an electronic display results in a display of a document's contents in a concise, logical, and focused manner. Visual cues such as shapes, colors, or both may also be used. Because of the rules governing abstracts, this abstract should not be used to construe the claims.

### TECHNICAL FIELD

This description generally relates to electronic displays of text and other information, and, more particularly, to a vertical alignment-based, content navigation methodology for a document to be displayed electronically.

### BACKGROUND

### Brief Description of Related Art

There have been many approaches to display and organize a document's contents on an electronic display (e.g., a computer monitor). In one approach, all the contents are presented on the display in a horizontal, sequential manner. In that case, a user has to vertically scroll the electronic display up and/or down to access specific material. In another approach, the document's contents may be presented in a tabular form (e.g., in vertical columns of information) on the display, and, the user may have to horizontally “jump” across the display screen to look at different contents.

In a hospital environment, a patient's plan of care may be displayed on a computer terminal (or any other similar video monitor, including a hand-held display device) to assist the clinician in performing the desired treatment for the patient. FIG. 1 illustrates a computer screenshot for a prior art plan of care display screen 10. The display screen 10 illustrates the screen to select one or more care designs and/or “problems” for a patient whose name may be listed on the top pane 11 of the screen 10. On the left hand side of the display screen 10, a category selection block 12 is provided to select a patient problem (or problems) to be addressed by manually highlighting the problem(s) from a care design master list of problems (which is shown in the form of a drop-down list in FIG. 1) and then “adding” or “moving” the highlighted problem(s) to the selected care design block 14 as illustrated for the Orth-Laminectomy problem in FIG. 1. Various selection “buttons” 15 on the Care Design screen 10 may be used to transfer or “add” the selected problem(s) to the care design block 14 or to “remove” or “edit” the entries in the block 14 as is known in the art. In the illustration of FIG. 1, an “Allergy” button 16 is provided at the top of the screen 10 to alert the clinician to potential allergy issues associated with a care design problem selected in the block 12. The Allergy button 16 may be clicked by the clinician to toggle the display from the screen 10 to another screen (not shown) displaying relevant allergy information. The Allergy tab 16 may be highlighted with a color (e.g., red color) to draw attention. The clinician may toggle back to the screen 10 when done with reviewing information on the Allergy screen (not shown).

It is noted that a patient problem may have one or more “goals” or “outcomes” associated with it. Each goal or outcome is an expected result that a clinician anticipates when performing a number of “interventions” or carrying out a number “orders,” or “actions” associated with the selected goal or outcome. For example, in FIG. 2, a screenshot is shown of a Phase Manager display screen 18 illustrating nursing actions or interventions 20 along with their individual status (e.g., active or inactive) for the selected care design problem of Orth-Laminectomy. In the embodiment of FIG. 1, a clinician may double click on the selected/highlighted problem in the block 14 to arrive at the Phase Manager's Outcome/Order screen 18 for the particular problem. It is observed here that in the display screen 18 in FIG. 2, only nursing actions or orders 20 are shown for the Orth-Laminectomy problem because the hospital or another patient administrator (including, for example, a doctor) may not have yet setup or associated the desired goals or outcomes with the Orth-Laminectomy problem. FIG. 3, on the other hand, shows a Phase Manager Outcome/Order screen 22 for the care design problem of LMN CD (selected in the Care Design field 24). The two outcomes assigned to the problem are shown in the display block 26 followed by three nursing orders or actions associated with the displayed outcomes for the selected problem of LMN CD. The status of each outcome and NUR (nursing) action is also shown in the right-hand side of the block 26.

It is seen from FIGS. 1-3 how contents of a document containing information about a patient problem and its associated outcomes and orders may be presented. In the embodiment of FIGS. 1-3, two different software application modules (e.g., the Assign Care Designs module and the Phase Manager module) are used to display the problems, goals and interventions using various “windows” or screens to display different, but related, pieces of information.

FIG. 4 depicts a different prior art screenshot 28 illustrating display and arrangement of various outcomes or goals for a selected patient problem. In the embodiment of FIG. 4, a user has chosen to display outcomes related to an Interdisciplinary Patient Problem List selected through a drop-down list in the field 30 on the screen 28. The desired outcomes or goals related to the selected problem are highlighted and displayed on a spreadsheet-style display window 32 on the screen 28. Some of the outcomes highlighted in FIG. 4 are “Individual Needs,” “Communication Needs,” “Discharge,” etc. The user may double-click on the “Action Plan” entry listed below the highlighted outcome to obtain further information about actions (or interventions) related to the specific outcome. Additional outcomes may be viewed by scrolling down the window 32 as is evident from the screenshot 28 in FIG. 4. The user may be allowed to enter comments or select one or more of pre-entered notes for an outcome-related entry listed below the outcome as shown, for example, by the comment fields 34 in FIG. 4.

It is seen here that although the display scheme in the embodiment of FIG. 4 provides a compact and organized representation of all problem-related outcomes/goals in a single screen 28, the display scheme does not support a comprehensive display of interventions/actions related to each goal displayed. A user may still need to switch to different screens/windows to obtain the desired information about related actions. Furthermore, the display methodology in FIG. 4 is well-suited only when the names or explanations of the displayed outcomes/goals are very short in length (e.g., 2-3 words long). That may not always be the case, especially when a hospital wishes to implement standardized nomenclatures for the problems and goals. In such a standardized format, the problems and goals may be expressed in longer statements as opposed to very short 2-3 word phrases illustrated in FIG. 4. Therefore, the spreadsheet-style display scheme of FIG. 4 may not be suitable to display problems, goals, and interventions that consist of several words occupying more display space. Furthermore, the use of non-standardized nomenclature in FIG. 4 may require that the reader of such information be familiar with such usage and be adept at comprehending the full content of the compact representation in a short time. Such a requirement may put additional pressure on the nursing staff when it comes to extracting relevant information from the displayed data in a timely manner.

FIG. 5 is another prior art screenshot 36 showing a tree-based document navigation scheme. In the content display scheme of FIG. 5, a left-hand pane 38 allows a user to select a desired folder, sub-folder, or document whose content may then appear in the right-hand pane 40. The list of selectable folders, their sub-folders, or documents within the sub-folders may be arranged in a tree-type structure shown in the pane 38 and known to one skilled in the art. In the embodiment of FIG. 5, the patient Discharge Summary illustrated in the right-hand pane 40 provides no way for the user to quickly navigate through the Summary document on display. The user has to scan the whole document on display in the pane 40 to see what is in the document and to reach a desired location in the document. Thus, although there are predictable sections of this discharge summary that may be quickly navigated, no such navigation mechanism is provided in the display scheme in FIG. 5. Furthermore, the view in the right-hand pane 40 may switch every time the user selects a different entry in the left-hand pane 38. In other words, the display methodology in FIG. 5 may require a user to open additional screens 36 to obtain simultaneous display of two documents containing related information.

In another prior art document navigation scheme, a plan of care for a patient is displayed on a computer screen (not shown) with the problems listed in a group box list (not shown) at the top of the screen. When a user selects one of the listed problems, the goals associated with the selected problem are listed in a list box (not shown) below the problem box on the screen. The interventions or actions associated with the displayed goals are broken out into two types—assessments and treatments, which are then listed in two separate list boxes (not shown) placed side by side below the list box for the goals. Such a display arrangement is difficult to scan for relevant information because the user has to click on a problem first to see the associated goals/interventions, and then the user has to scroll through list boxes if there are many entries in the list boxes for goals/interventions. Furthermore, even though all the related data is displayed on a single screen (not shown) and even though the interventions are divided into two types, that is not sufficient to convey useful information to the user unless the user is significantly familiar and conversant with the display scheme. For example, there is no way for the user to figure out from the display which interventions are associated with which groups. Thus, additional work on the part of the user may be required to obtain further information on goal-specific interventions.

FIG. 6 illustrates a partial screenshot 42 in another prior art content display scheme displaying a summary of all PNDS (Perioperative Nursing Data Set) data recorded for a surgical case. Only a portion of the Case PNDS page (not shown) is shown as the screenshot 42 in FIG. 6. It is seen from FIG. 6 that the display 42 shows the nursing diagnoses (or problems) for the surgical case along with associated patient outcomes (or goals) and interventions (or actions) on a single display screen. However, patient outcomes and interventions are provided in an active hyperlink format that has to be clicked by a user to access additional information for the selected outcome or intervention. For example, clicking any of the hyperlinks 44 takes the user to the full Case PNDS screen (shown in FIG. 7 and discussed later hereinbelow) in which all information for the selected Patient Outcome is displayed. Similarly, clicking any of the hyperlinks 46 results in display of the full Case PNDS screen (FIG. 7). However, in this latter case, the user is not taken to the beginning of the page (as is the case when a hyperlink 44 is clicked), but, instead, the displayed page automatically scrolls to the selected Intervention.

FIG. 7 shows a computer screenshot that depicts the format of a full Case PNDS page 48 that is displayed when one of the hyperlinks 44 related to Patient Outcomes on the screen 42 in FIG. 6 is clicked by a user. In the embodiment of FIG. 7, the user has clicked the “O1” hyperlink 44 in FIG. 6, which results in displaying of all information related to that single Patient Outcome (“O1”) on page 48. Other pertinent information related to the selected outcome “O1”—i.e., related nursing diagnosis, outcome indicators, nursing interventions, etc.—is also displayed on the page 48 as shown in FIG. 7. The user may navigate among nursing interventions related to the selected outcome by clicking on the “Up” or “Down” links 50 to view the next or previous nursing intervention on the displayed page 48. To select a different Patient Outcome, however, the user must execute a search using the search button 52, or navigate back to the main page (shown in FIG. 6) where the full list of Patient Outcomes is presented.

It is observed with reference to the display scheme in FIG. 7 that the user cannot view nursing interventions or activities only without having to view all the information related to the selected Patient Outcome. Furthermore, the user cannot directly navigate among interventions across all Patient Outcomes displayed (e.g., the outcomes displayed on the screenshot 42 in FIG. 6). In other words, in the display scheme of FIG. 6, the user cannot directly navigate among all interventions related to outcomes “O1”, “O10”, and “O12” displayed on the screen 42; the user can navigate only among the interventions for a specific outcome selected by the user as can be seen from the display 48 in FIG. 7. Similarly, in the embodiment of FIG. 7, the user cannot directly navigate among Activities within the currently selected Patient Outcome; the user can only navigate among the interventions using the Up/Down links 50. Also, as in the case of interventions, the user cannot navigate among Activities related to different Patient Outcomes. It is noted here that an “activity” may be referred to as a task level list of what a nurse or other patient administrator must do to execute the “intervention” that has been attached to the patient's case. In other words, an “activity” may be considered a task-level description of what must be done to achieve the desired patient outcome, whereas, an “intervention” or “action” may be considered a high-level description of what must be done to achieve the desired patient outcome or goal.

Hence, it is desirable to devise a document navigation methodology or scheme for reliable user interpretation of and navigation within complex documents, whether arising in a hospital setting or in any other environment. When the documents contain hierarchical or nested collections of information (e.g., the problem-goal-intervention-activities type hierarchical information in a hospital document system discussed above), it is further desirable that the information be presented to the viewer/user in a concise, logical, and focused manner so as not to distract the user with irrelevant details or waste the user's time with inefficient searches for needed information.

### SUMMARY

In one general aspect a method of electronically displaying data comprises displaying a plurality of items in a first row, wherein each of the items is displayed at an assigned horizontal position within the row. The method also comprises displaying data related to at least certain of the items in subsequent rows below the first row, wherein each of the subsequent rows has a horizontal starting point which is substantially the same as a horizontal starting point of the position assigned to the item related to the data displayed in the respective subsequent row. Implementations of the methods described may include hardware, i.e., an electronic display, for displaying the data in this manner.

In a preferred embodiment, a data storage medium contains program code, which, upon execution by a processor in a computing system, causes the processor to display a plurality of items in a first row of an electronic display in the computing system, wherein each of the displayed items has an assigned position within the row. The program code, upon execution by the processor, also causes the processor to display data related to at least some of the items in subsequent rows on the electronic display below the first row, wherein each of the subsequent rows has a horizontal starting point on the electronic display which is substantially the same as a horizontal starting point of the position assigned to the item related to the data displayed in the subsequent row. Implementations may include a processor programmed in this manner as well as a system comprising a computing unit containing a processor configured to execute program code; an electronic display operatively connected to the computing unit to display thereon information supplied thereto by the processor; and a data storage medium, carrying programming of the type previously mentioned, operatively connected to the computing unit.

Another preferred embodiment comprises, a document viewer for viewing an electronic document containing a plurality of items and related data on an electronic display. The document viewer comprises means for assigning a display position to each of the plurality of items; means for displaying the plurality of items in a first row, wherein each of the items in the first row is displayed at the display position assigned thereto; and means for displaying data related to at least certain of the items in subsequent rows below the first row, wherein each of the subsequent rows contains data related to one of the items and has a horizontal starting point which is substantially the same as a horizontal starting point of the display position assigned to the one item.

An additional preferred embodiment comprises, a method comprising the steps of receiving over a communication network an electronic document containing a plurality of items and related data from a site or client site that may be a remote site; organizing the content of the electronic document to generate a revised electronic document therefrom; and sending the revised electronic document to the site over the communication network. The revised electronic document, when displayed on an electronic display at the site, contains a plurality of items displayed in a first row on the electronic display, wherein each of the items is displayed at an assigned position within the first row. The revised electronic document, when displayed on the electronic display at the site, also contains data related to at least certain of the items displayed in subsequent rows below the first row. Each of the subsequent rows contains one or more bits of data related to one of the items and has a horizontal starting point which is substantially the same as a horizontal starting point of the position assigned to the one item. Implementations may include a communication network-based system including a host computer and a client computer programmed to perform this preferred method of generating and displaying the revised electronic document.

Further preferred embodiments may comprise a visual document navigation scheme in which items and their related data are displayed in a vertically aligned manner using horizontal indentations to visually link an item and its related data. Visual cues such as color or shapes may also be used to enhance the presentation. A document navigator control according to a preferred embodiment accomplishes such display methodology to facilitate accurate document viewing and efficient document navigation in a fast-paced, multi-tasking environment (e.g., a nurse or clinician on duty in a hospital). The use of vertically-aligned positional indicia or markers by the document navigator program to place an item and its related data at substantially the same horizontal starting point on an electronic display results in a display of a document's contents in a concise, logical, and focused manner. Elimination of irrelevant details or time-consuming “switching” among various screens of information significantly reduces clutter or distractions and improves user comprehension and retention of visual information, thereby improving the efficiency and accuracy of document viewing.

### BRIEF DESCRIPTION OF THE DRAWINGS

FIG. 1 illustrates a computer screenshot of a prior art plan of care display screen;

FIG. 2 shows a screenshot of a Phase Manager display screen illustrating nursing actions or interventions along with their individual status for the selected care design problem of Orth-Laminectomy in FIG. 1;

FIG. 3 is related to FIG. 2 and depicts a Phase Manager Outcome/Order screen for the care design problem of LMN CD selected from a Care Design field;

FIG. 4 depicts a different prior art screenshot illustrating display and arrangement of various outcomes or goals for a selected patient problem;

FIG. 5 is another prior art screenshot showing a tree-based document navigation scheme;

FIG. 6 illustrates a partial screenshot in another prior art content display scheme displaying a summary of all PNDS (Perioperative Nursing Data Set) data recorded for a surgical case at hand;

FIG. 7 shows a computer screenshot that depicts the format of a full Case PNDS page that is displayed when one of the hyperlinks related to Patient Outcomes on the screen in FIG. 6 is clicked by a user;

FIG. 8 illustrates a generalized operational flow for a preferred document navigator program;

FIG. 9 depicts an exemplary setup for implementing a preferred document navigator program;

FIG. 10 is a simplified flowchart depicting operation of a preferred document navigator program;

FIG. 11 is an exemplary computer screenshot depicting an overlaid window displaying a hierarchical data content in the manner specified in the flowchart of FIG. 10;

FIG. 12 illustrates an exemplary screenshot that may be displayed on a display screen (not shown) when the user selects the “Deficient Knowledge” problem entry in the window of FIG. 11; and

FIG. 13 is another screenshot similar to the screenshot of FIG. 12, but depicting a detailed display layout of goals and interventions related to another problem selected by a user.

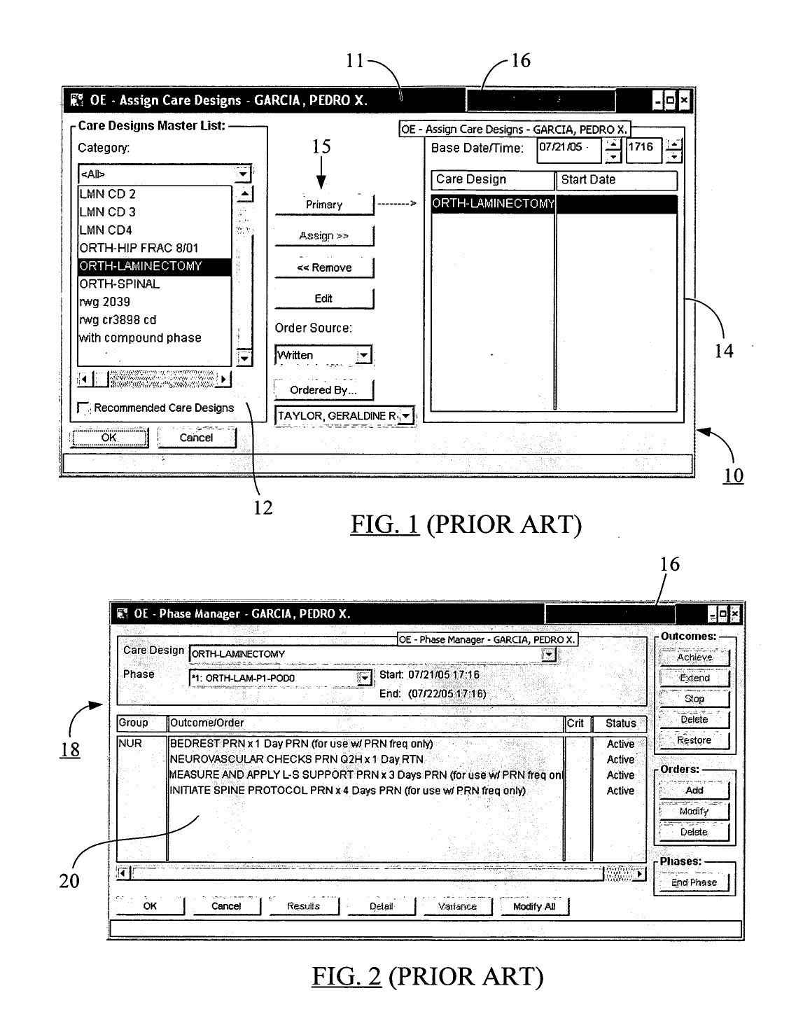

### DETAILED DESCRIPTION

Reference will now be made in detail to certain preferred embodiments, examples of which are illustrated in the accompanying drawings. It is to be understood that the figures and descriptions included herein illustrate and describe elements that are of particular relevance to the preferred embodiments, while eliminating, for the sake of clarity, other elements found in typical electronic document display devices or content display systems and software. It is noted at the outset that the terms “document navigator”, “content navigator,” or “document navigation” as used herein are used in their broadest sense to refer to content navigation in any form of electronic data presentation, whether in a document form or not. Furthermore, the term “data,” as used hereinbelow, refers to an item-related electronic content in any form-text, symbol, graphics, colors, etc.

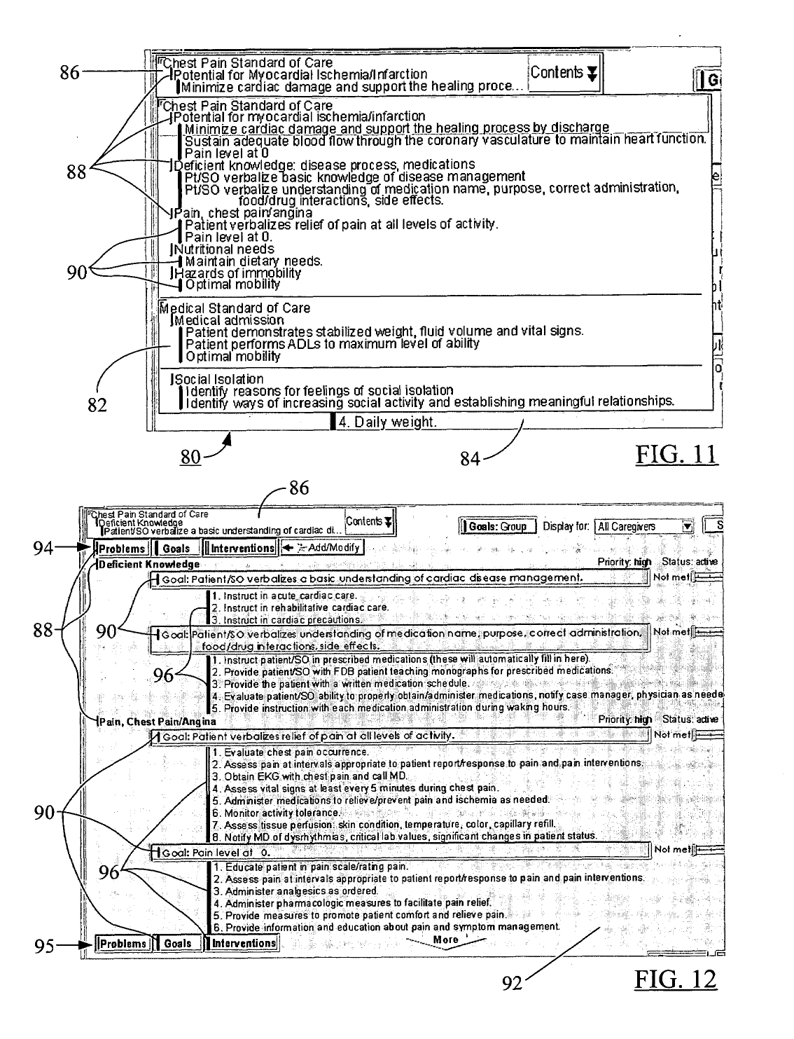

FIG. 8 illustrates a generalized operational flow for a document navigator program according to a preferred embodiment. The document navigation program (simply, the “document navigator” or “content navigator”) is represented by the block 58. Even though the document navigator may contain a number of program modules or program code blocks, for simplicity and ease of discussion, the reference numeral “58” is used hereinbelow to refer to the document navigation software designed to implement the teachings of one or more preferred embodiments hereof. The document content to be displayed (block 57, FIG. 8) may be an unorganized collection of data input to the document navigator 58, which may operate on the received data content to organize and display the content (block 59, FIG. 8) in the manner discussed hereinbelow with reference to FIG. 10. In another preferred embodiment, the contents of a document to be displayed may be stored in an electronic memory in the desired form (discussed with reference to FIG. 10) and the document navigator 58 may then just perform the display function to display the contents in the desired form on an electronic display.

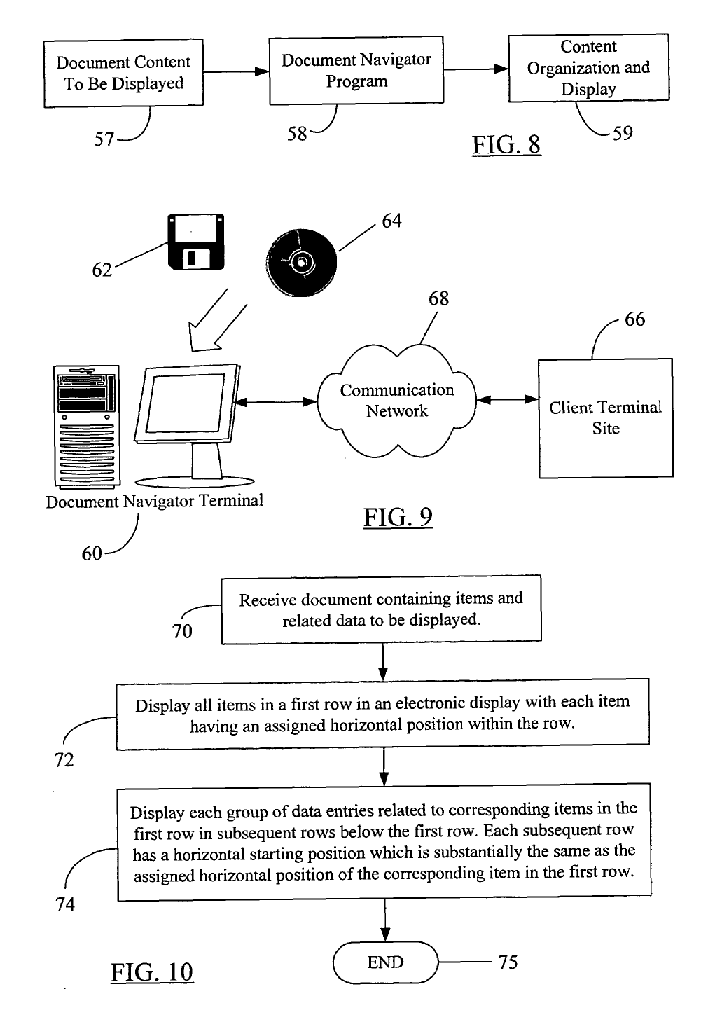

FIG. 9 depicts an exemplary hardware setup for implementing the document navigator program 58 according to a preferred embodiment hereof. A document navigator terminal or computer 60 may execute or “run” the document navigator program application 58 when instructed by a user (e.g., a nurse or other patient administrator in case of a hospital setting). Upon execution of the document navigator program 58, the content of the desired document may be displayed on the computer terminal or monitor display screen of the document navigator terminal 60 in an indented manner discussed hereinbelow with reference to FIG. 10. The program code for the document navigator program application 58 may be stored on a portable data storage medium, e.g., a floppy diskette 62, a compact disc 64, a data cartridge tape (not shown) or any other magnetic, solid state, or optical data storage medium. The document navigator application 58 will likely be a module available to a much larger program.

The document navigator terminal 60 may include appropriate disk drives to receive the portable data storage medium and to read the program code stored thereon, thereby facilitating execution of the document navigator software 58. In a preferred embodiment, the document navigator program 58 may reside directly on a hard drive (not shown) of the navigator terminal 60. The document navigator software 58, upon execution by a processor of the computer 60, may cause the computer 60 to perform a variety of data processing and display tasks including, for example, retrieval of relevant data for the document to be displayed, preparation of the retrieved data for display, arrangement and organization of the data in the manner discussed hereinbelow with reference to FIG. 10, changes in the content to be displayed when indicated by the user (e.g., using a computer keypad, mouse, or similar instruction input device), transmission of the displayed content and its format of display to a remote computer site 66 (discussed in more detail hereinbelow), etc.

As illustrated in FIG. 9, in a preferred embodiment, the document navigator terminal 60 may be accessible from a client terminal site 66, remote or otherwise, via a communication network 68. The communication network 68 preferably may comprise an Ethernet LAN (local area network) connecting all the computers or data processing units within a facility, e.g., a university research laboratory, a corporate data processing center, a hospital, etc. In that case, the document navigator terminal 60 and the client terminal 66 may be physically located at the same site, e.g., a university research laboratory or a hospital. In alternative embodiments, the communication network 68 may include, independently or in combination, any of the present or future wireline or wireless data communication networks, e.g., the Internet, the PSTN (public switched telephone network), a cellular telephone network, a WAN (wide area network), a satellite-based communication link, a MAN (metropolitan area network), etc.

The document navigator terminal 60 preferably may comprise, e.g., a personal computer (PC), a laptop computer, a workstation, a minicomputer, a mainframe, a handheld computer, a small computing device, a graphics workstation, or a computer chip embedded as part of a machine or mechanism (e.g., a computer chip embedded in a tablet PC or an electronic display, etc.). Similarly, the terminal (not shown) at the client site 66, remote or otherwise, may also be capable of reading and manipulating (e.g., editing) the content of a document transmitted by the document navigator terminal 60. In a preferred embodiment, the client terminal site 66 may also include the document navigator terminal 60, which may function as a server computer accessible by other computers at the client site 66 via a LAN. Each computer—the document navigator terminal 60 and the remote computer or other electronic display terminal (not shown) at the client site 66—may include requisite data storage capability (to store, for example, the data to be displayed) in the form of one or more volatile and non-volatile memory modules. The memory modules may include RAM (random access memory), ROM (read only memory) and HDD (hard disk drive) storage. In another preferred embodiment, the document navigator 58 may also reside on a computer terminal (not shown) at the site 66, remote or otherwise.

Before discussing how the software of a preferred embodiment of document navigator 58 functions, it is noted that the arrangement depicted in FIG. 9 may be used to provide a commercial, network-based document content arrangement and display service that may perform customer-requested document content organization and display. For example, the document navigator 58 resident on the document navigator terminal 60 may be configured to organize and present the contents of a document (in the manner discussed below with reference to FIG. 10) submitted or transmitted to the document navigator terminal 60 over the communication network 68 (e.g., the Internet) by an operator at the client site 66 and, then, transmit the content to be displayed at an electronic display terminal (not shown) at the site 66 in the manner discussed below with reference to FIG. 10. The entire process of data receipt and delivery of processed content can be automated. It is noted that the owner or operator of the document navigator terminal 60 may offer commercially a network-based document content presentation service, as illustrated by the arrangement in FIG. 9, to various individuals, corporations, hospitals, universities, or other facilities on a fixed-fee basis, on a per-operation basis or on any other payment plan mutually acceptable to the service provider and the service recipient.

FIG. 10 is a simplified flowchart depicting operation of a preferred embodiment of the document navigator program 58. Initially, as noted with reference to FIG. 8 hereinbefore, the software comprising the document navigator 58 may electronically receive the document containing items and related data to be displayed. The document to be displayed may reside in a data storage portion or memory of the document navigator terminal 60 that may be separate from the memory unit or data storage portion containing the software program code of the document navigator. The content of the document to be displayed preferably may be provided as an input to the document navigator program 58, which, in turn, may operate on the received content and organize the content in a manner discussed below with reference to blocks 72 and 74 in the flowchart of FIG. 10. The processing unit or processor (not shown) in the document navigator terminal 60 preferably may be configured to provide the appropriate content input to the document navigator program 58. The document navigator program 58 preferably may be configured to receive and process an instruction from a user (not shown) to retrieve and display a specific document, and then instruct the processor (not shown) to retrieve and supply to the document navigator program 58 the appropriate document to be displayed. The document navigator program 58 may then process the document to be displayed in the manner discussed below with reference to blocks 72 and 74 of FIG. 10.

Referring to FIG. 10, it is assumed that the contents of the document to be displayed have been processed and stored in appropriate display fields that may be “recognized” by the document navigator program 58 when displaying the document on an electronic display (e.g., a computer monitor of the navigator terminal 60). However, as noted hereinbefore, if the document has not been pre-processed in such manner, the document navigator program 58 may be configured to process the document in a manner that results in the organization and display of its contents in the manner discussed with reference to blocks 72 and 74 in FIG. 10. As shown in block 72, the document navigator 58 preferably displays all items in the received electronic document content in a first row in an electronic display (not shown) (e.g., the display screen or computer monitor of the navigator terminal 60). The document content may include a number of items and related data to be displayed on the display screen. The items, as discussed hereinbelow, may be related hierarchically to one another or may be disjointed pieces of information with each item having its own associated data content to be displayed. Each item in the first row preferably has an assigned position within the row, whereby the item displayed in each subsequent row preferably begins at a corresponding horizontal position assigned to that item. The item-specific horizontal position assignment may be part of the program code of the document navigator 58, and may be suitably changed or re-programmed by an authorized operator. The term “first”, as in the phrase “first row”, is used for simplicity and ease of discussion only. The usage of the term “first” herein does not necessarily mean that the placement and display of the row of items must be in the top-most or physically-first row of display on the electronic display where the document is being displayed by the document navigator 58. On the contrary, the term “first” is used herein as a relational term in the context of the overall display pattern followed by a preferred embodiment of the document navigator 58. Thus, as observed in the context of a data display recited in block 74 in FIG. 10, the term “first” refers to the placement of the row of items before the subsequent rows of related data entries are displayed on the electronic display. Such placement, as noted here, may begin, for example, at the middle or other physical location on the display screen as can be seen from the exemplary screenshot of FIG. 12 discussed hereinbelow.

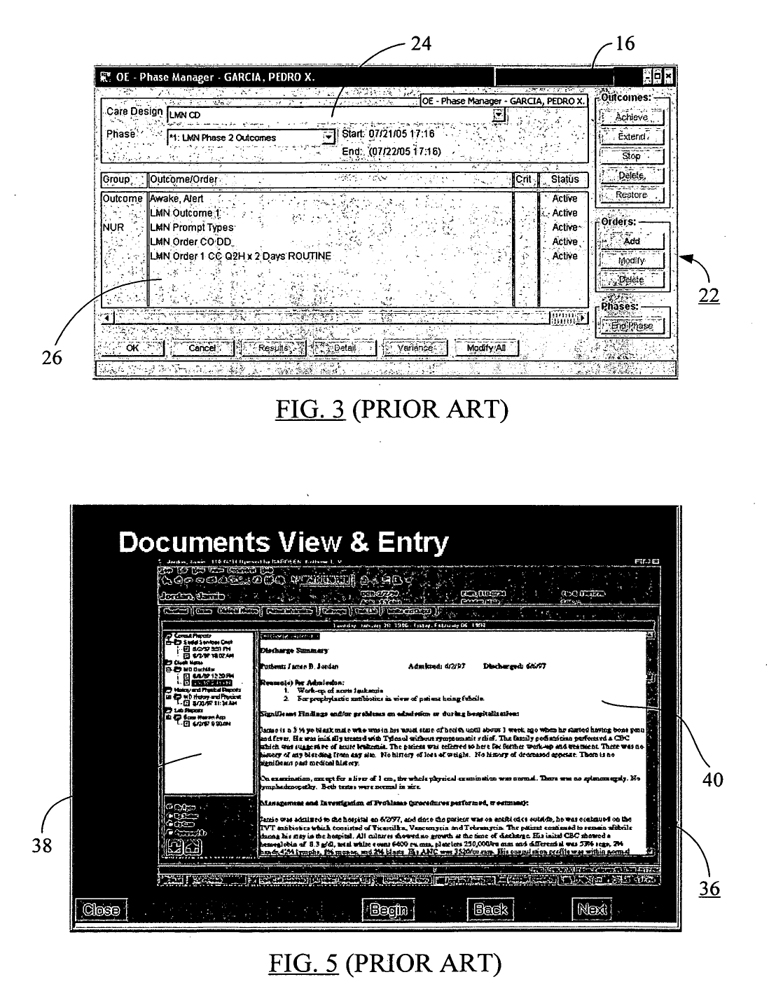

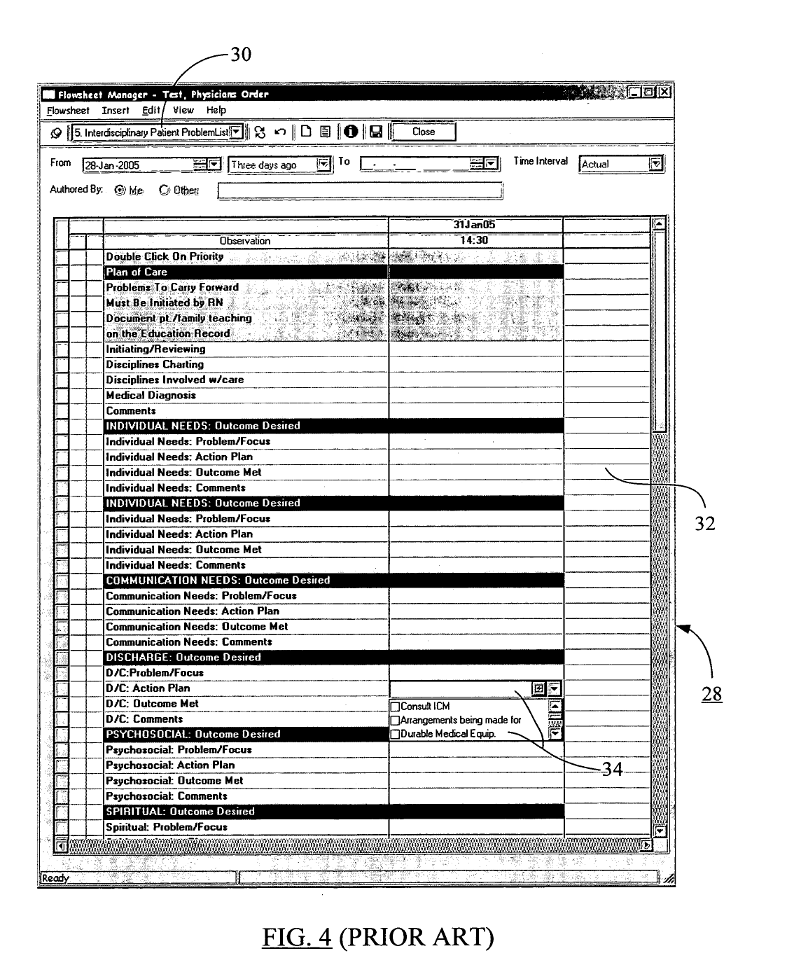

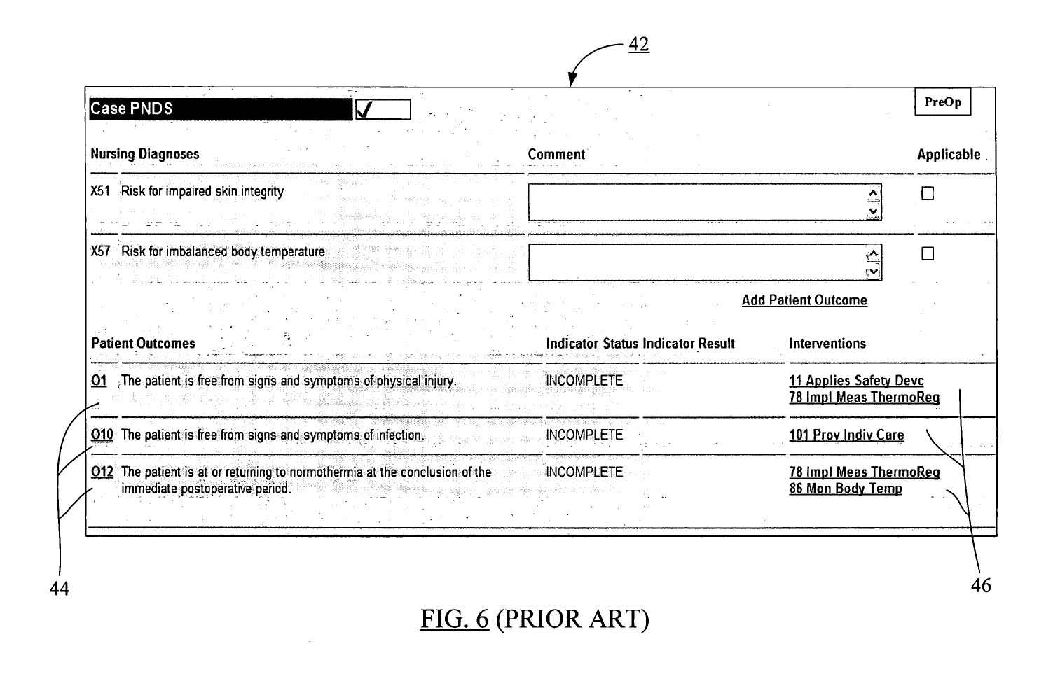

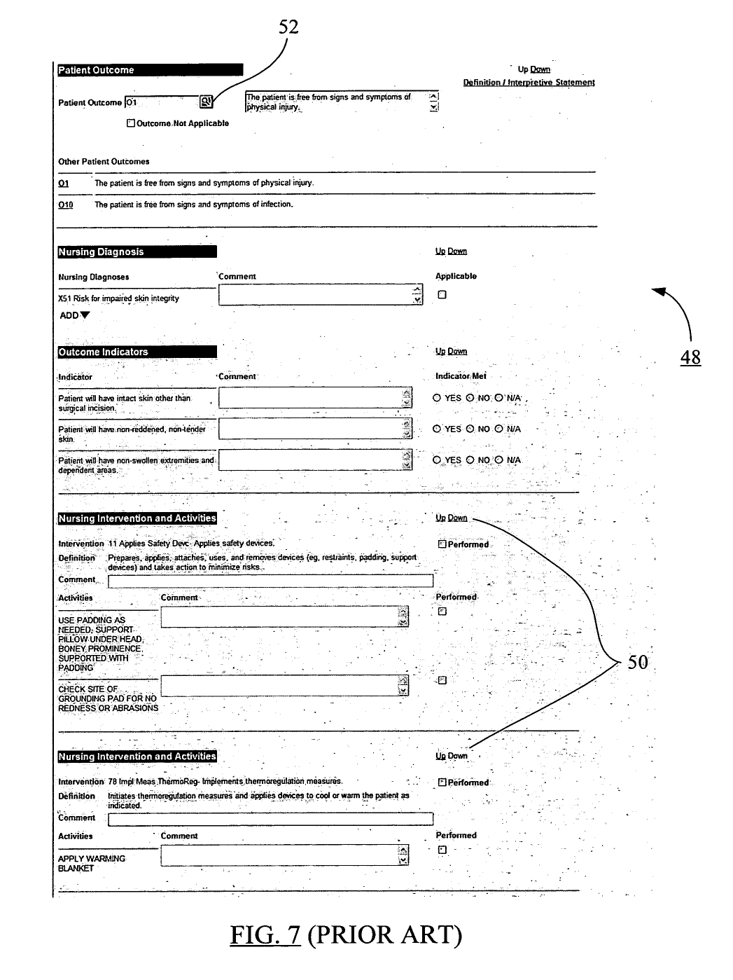

After a first row of items is displayed, the document navigator 58 may display, in subsequent rows below the first row, each group of data entries related to corresponding items in the first row. However, instead of simply displaying the data content in a left-aligned manner (as shown, for example, in FIGS. 3 and 7), the document navigator 58 provides an indented display format wherein each subsequent row of data has a horizontal starting point which is substantially the same as the horizontal starting point of the assigned position of the corresponding item in the first row (block 74, FIG. 10). Thus, as shown for example in FIG. 12 (discussed hereinbelow), all data related to a specific item is placed below and aligned with the position of the corresponding item in the first row of items. Such indented placement or layout of item-related data provides for easy visual linking (or association) between the item and its related data, thereby facilitating a quick and efficient extraction of relevant information when such arrangement is viewed by a user (e.g., a nurse in a hospital). Additional discussion of the visual functionality and utility of the display methodology employed by document navigator 58 is provided hereinbelow with reference to the exemplary screenshots in FIGS. 11-13. The document display process may terminate at block 75 as illustrated in FIG. 10.

FIG. 11 is an exemplary computer screenshot 80 depicting an overlaid window 82 displaying a hierarchical data content in the manner recited in the flowchart of FIG. 10. As shown in FIG. 11, a plan of care display contained in window 82 is shown with its content (including, for example, a standard of care, problems, goals, etc.) organized in a summary form according to the methodology described hereinbefore with reference to FIG. 10. A condensed version of the plan of care contents is displayed in the window 82 that may be overlaid on an application workspace 84 portion of the screenshot 80 as shown in FIG. 11. In an alternative embodiment, the document navigator 58 preferably may be configured to display a separate window (not shown) containing the contents of the window 82, but occupying the entire screen space in the screenshot 80 instead of a portion of the screen space as in FIG. 11. A scroll down window 86 may be provided on the top of the application workspace 84 for a user to choose the appropriate standard of care/problems/goals for a specific plan of care displayed in window 82. The document navigator 58 may be configured so that when a user chooses, e.g., by highlighting or clicking on, a specific row (of standard of care/problems/goals) in the window 86, that selected row may be displayed at the top in the overlaid window 82 as shown in FIG. 11, for example, for the highlighted “Chest Pain Standard of Care” row and its associated problems/goals.

As noted hereinbefore, in a hospital environment, the plan of care information may be organized in a hierarchical manner with each plan of care constituting a number of related “standards of care”. Each standard of care, in turn, may be constituted of associated “problems”, wherein each problem has its associated set of “goals” or “outcomes” that may be considered as the expected/desirable results of the “interventions” or “actions” to be performed by a clinician. Thus, there may be a specific set of interventions associated with each goal. The task-level acts performed by a clinician to execute an intervention may be referred to as “activities.” Hence, a number of activities may, in turn, constitute a given intervention. It is evident from the discussion herein that the terms “goal” and “outcome” are used interchangeably herein, so are the terms “actions” and “interventions.”

Thus, the hierarchical information may constitute a number of “items” (e.g., problems, goals, interventions, etc.) that can be organized or displayed in a descending order starting with the standard of care, followed by its associated problems, goals, interventions, and activities. One such arrangement is illustrated in FIG. 11 in which the standard of care item is followed by its problems and goals, but no display of related data on interventions or activities is shown. For example, in FIG. 11, the “Chest Pain” standard of care row displayed above window 82 is followed by its associated problem “Potential for myocardial ischemia/infarction”, which, in turn, is followed by three associated goals: “Minimize cardiac damage . . . ,” “Sustain adequate blood flow . . . ”, and “Pain level at 0”, all sequentially indented as shown. Similarly, other groups of problem-goals information are displayed below this first group-one group followed by another, each group having the same sequential indentation within the group.

As shown in FIG. 11, the document navigator 58 operates to display the items that are at the same hierarchical level at the same horizontally indented distance in the window 82. In other words, items of a common hierarchical level are displayed in a vertically aligned manner as shown in FIG. 11. For example, in FIG. 11, all problems associated with the Chest Pain standard of care are displayed at the same horizontal starting position identified by the “markers” or other indicia referred to by the reference numeral “88”. Similarly, all information related to the “goal” item (which is hierarchically “lower” than the “problem” item) is displayed in a vertically aligned manner indicated by the markers 90 in FIG. 11. Thus, the document navigator 58 may be configured so that the highest order item in the hierarchy of items (e.g., the standard of care item) may be displayed starting at a leftmost location in the window 82, whereas each hierarchically lower order item is displayed below at a horizontally rightward indented location. The lower the order of an item in the hierarchy of information, the farther the item-related information is indented from the leftmost position on the window 82. It is observed, however, that such hierarchy is pre-defined and programmed into the document navigator 58 so as to allow the navigator to appropriately arrange and display the hierarchical document information.

Preferably, the horizontal starting position markers or indicia (e.g., markers 88 or 90 in FIG. 11) may be provided as colored bars, symbols, colored symbols, or other suitable indicia. In such a color scheme, the same color may be used for each item and its related data. Thus, for example, all bars 88 shown in FIG. 11 may be displayed in the brown color, whereas all bars 90 may be in the blue color. Instead of colored bars, other suitable item-specific symbols may be employed. For examples, a star symbol (not shown) may be placed at the horizontal starting position of all problems displayed in the window 82; whereas, a square box (not shown) may be placed at the horizontal starting position of all goals displayed in the window 82. Such symbols may or may not be shown in one or more colors. Additionally, highlighting of rows may be used to show the context of the application workspace (for example, the Standard of Care, the Problem and the Goal that are displaying in the application workspace).

As illustrated, the indented and vertically aligned display arrangement of FIG. 11, visually organizes all related texts/data for efficient viewing and comprehension by a user. The user can quickly gather the relevant information from the indented layout produced by the document navigator 58. In the condensed display of window 82, all the relevant information for a plan of care document is easily available and displayed in the full text form instead of difficult to recognize phrases of 2-3 words. The full text display is accommodated seamlessly in the entire display layout without occupying substantial display screen space, as can be seen in window 82 of FIG. 11. Other information not shown in the window 82 may be displayed for the user's reference when the user selects a different standard of care from the window 86 as noted hereinbefore. The top three rows in window 82 preferably may be highlighted to distinguish the standard of care, problem, and goal displayed at the top of window 82, as shown in FIG. 11. Other suitable indication methodology may be employed to draw a user's attention to the selected standard of care and its associated data.

The entire document outline displayed in window 82 for the Chest Pain standard of care, for example, allows a user (e.g., a nurse) to quickly glance at the information presented and, if the user is interested in more details, the user may select any row displayed in window 82 to directly navigate to that portion of the document. The user also may change the displayed screen 82 by selecting something different from the scroll down window 86 as noted hereinbefore. For example, if a user wishes to obtain more information about the “Deficient Knowledge . . . ” problem shown below the “Potential for myocardial/schemia/infarction” problem (each displayed at the same horizontal position 88), the user may select the “Deficient knowledge . . . ” row (e.g., by highlighting or single or double clicking the row as recommended by the designer of the document navigator 58). The document navigator 58 may auto scroll the document to the desired section and display the selected item in window 86 at the top of another window (e.g., the window 92 in FIG. 12) that may replace the previous window 82. FIG. 12 illustrates an exemplary screenshot 92 that may be displayed on the display screen (not shown) when the user selects the “Deficient Knowledge” problem entry in the window 82 in FIG. 11. The screenshot or window 92 depicts the hierarchical, visual display of detailed information related to the selected “Deficient Knowledge” problem, as well as other problems/goals that were displayed below the “Deficient Knowledge” entry in the window 82 in FIG. 11. Although the application workspace 84 is not shown in FIG. 12, it is noted here that the window 92 may be overlaid on the workspace 84 in the same manner as and in place of the window 82 of FIG. 11. The scroll down window 86 may remain on the top of the display screen as shown in FIG. 12.

As shown in FIG. 12, a first row 94 on the display 92 shows all items of interest displayed side-by-side at assigned horizontal positions within the row 94. In case of a hierarchical set of items, the display navigator 58 may be programmed with corresponding horizontal locations (also referred to as the “assigned horizontal positions”) for the items to be displayed in the first row 94 in the window 92. The assigned horizontal starting positions of each item in the row 94 may be referred to by the markers 88, 90, and 96. For example, the marker location 88 relates to placement and display of all data related to the item titled “Problems” in the first row 94. Similarly, the marker location 90 relates to placement and display of all data related to the item “Goals”, and the marker location 96 may be associated with the placement and display of all data related to the item “Interventions” in the first row 94. As noted before, in the embodiment of FIG. 12, items in the first row 94 are placed in a descending order because of the hierarchical nature of the items. Thus, the hierarchically highest order item (“Problems”) is placed first (or at a left most location in row 94 in the window 92), whereas the hierarchically lowest order item (“Interventions”) is placed horizontally farthest in the row 94 from the first-placed item (“Problems”). All the items in the row 94 may be shown as “buttons” that may be clicked by a user (e.g., a nurse) to display the item-related information. In FIG. 12, all three items are shown selected by the user to display all relevant information. As shown in FIG. 12, although the “activities” for the displayed “Interventions” are not shown, a programmer may program the document navigator to add the “Activities” item (not shown) after the “Interventions” item in the row 94. The programmer may also provide additional relevant text to be displayed when a user selects the “Activities” button (not shown) in the row 94. Preferably, the order of the items displayed in the row 94 may be modified or other non-displayed items (and associated text if such text is stored as part of the document to be displayed) may be added on the display 92 by using the Add/Modify button 97. The content of the row 94 may be repeated at the bottom of the window 92 as indicated by the duplicate row 95 in FIG. 12. Such an arrangement provides additional visual cues or context to the user viewing the information in the window 92.

The detailed information about the selected “Deficient Knowledge” problem is displayed with each group of related information presented below the first row 94. Thus, entry for each goal associated with the displayed problem (here, the “Deficient Knowledge” problem) is followed by all goal-related interventions associated with that specific goal. After all the interventions are displayed for one goal, a second group of data is displayed starting with another goal and its associated interventions. Such successive displays of goals and respective interventions are continued until all goals and interventions associated with the displayed problem are exhausted. Thereafter, another problem (here, the “Pain, Chest Pain/Angina” problem in FIG. 12) may be displayed followed by its own set of goals and interventions. Such process is carried out until there is no display space available for the size selected for the window 92 as seen in FIG. 12. If a user wishes to view more information, the user may click on the “More” button 99. The “More” button 99 thus gives a visual feedback to the user that there is more information available to view or that the user has reached the end of the document in window 92. Alternatively, in another preferred embodiment, the user may continue scrolling down past the end of the display in the window 92 triggering the auto-scroll functionality of the document navigator 58 to display the next page of information in the window 92. As in case of the display 82 in FIG. 11, suitable markers or indicia (e.g., the markers 88, 90, and 96 in FIG. 12) may be placed at the horizontal starting positions of the data related to the corresponding items in the first row 94. The assigned horizontal positions of the items in the row 94 may also be marked with similar markers as shown in FIG. 12. The markers 96 for the item “Interventions” preferably may be in the form of green bars. As mentioned hereinbefore with reference to FIG. 10, each subsequent row of data in FIG. 12 displayed after the first row 94 has a horizontal starting point that is substantially the same as the horizontal starting point of the assigned horizontal position of the corresponding item in the first row 94 to which the data is related. This is evident from the substantial vertical alignment of all data markers 88 associated with the item “Problems” in the first row 94, all data markers 90 associated with the item “Goals” in the first row 94, and all data markers 96 associated with the item “Interventions” in the first row 94. The scheme of an indented and substantially vertically aligned display of related data illustrated in the outlined display of FIG. 11 is continued in the detailed display of FIG. 12.

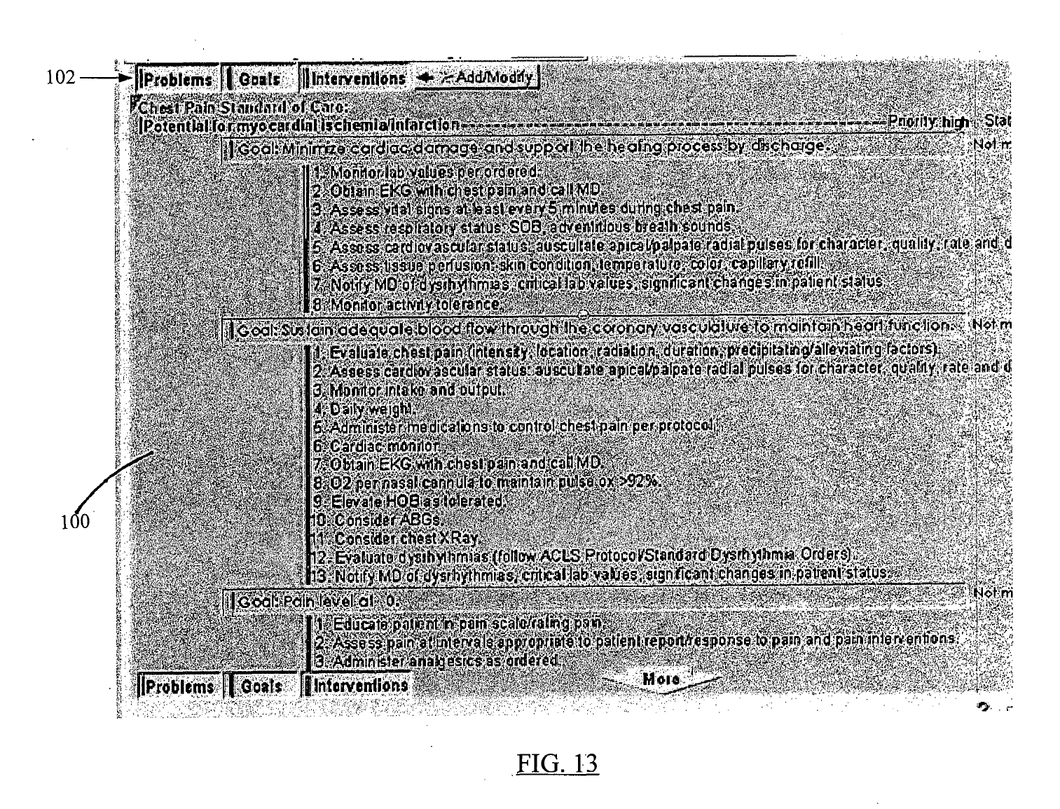

FIG. 13 shows another screenshot 100 similar to the screenshot 92 in FIG. 12, but depicting a detailed display layout of goals and interventions related to another problem selected by a user (using, for example, the selection window 86 on the display screen). Except for the display of the problem-specific text, the display 100 in FIG. 13 is substantially similar to the display 92 in FIG. 12 and, hence, additional discussion of the display in FIG. 13 is not provided herein. As shown in FIG. 13, however, the standard of care information preferably is displayed after the first row 102 (displaying the selected items in a descending order) and before the display of problem-related data (including goals and interventions associated with the selected problem of “Potential for myocardial ischemia/infarction”). Such an intervening display of the relevant standard of care is absent in the exemplary screenshot of FIG. 12. Additional display arrangements may be devised by one skilled in the art when the document navigator 58 is appropriately programmed.

The multi-level display arrangements in FIGS. 11-13 for hierarchical or nested collections of complex information may be considered “you-are-here” content navigation arrangements for the display of patient plan of care information. The closed control offered by the document navigator 58 orients the user (e.g., a nurse) to a precise location of the user's choice in the document the user is viewing in the visual application space. The open control in the embodiment of FIG. 11 displays a view of the entire document outline, allowing the user to quickly and reliably “jump” to any section of the document using the closed control of, for example, FIGS. 12-13. If distracted while viewing all the texts in the displayed document, the user may be quickly re-oriented on return of focus to the document with the help of the location-fixing markers (e.g., markers 88, 90, 96 in FIG. 12). Therefore, the user can navigate easily and efficiently throughout the displayed document without any clutter or distractions, and without any need to toggle various window screens to gather all the needed information. The document navigator 58 avoids the prior art displays of disjointed information by displaying all related information in one window page with position linking markers so as to expedite user comprehension and retention of visual information. The indented nature of the display with positionally-aligned markers according to the preferred embodiments disclosed herein results in an organized and easily comprehensible display of textual and other information without the need to shorten the displayed texts to a few words in length or to require the user to switch among a number of windows to navigate through the entire contents of the relevant document.

Preferably, the document navigator program 58 may be implemented as software code to be executed by a processor (not shown) (e.g., a processor in the navigator terminal 60 in FIG. 9) using any suitable computer language such as, for example, Java, Ada, Visual Basic, C or C++ using, for example, conventional or object-oriented techniques. Such software code may be stored as a single program module or a set of program modules performing different functions. The program modules may be stored on a computer-readable medium, such as a random access memory (RAM), a read only memory (ROM), a magnetic medium such as a hard-drive or a floppy disk (e.g., the floppy disk 62 in FIG. 9), or an optical medium such as a CD-ROM (e.g., the CD ROM 64 in FIG. 9). The software code for the document navigator 58 preferably may contain a series of instructions or commands provided to accomplish the document presentation, display, and navigation methodology discussed herein with reference to the embodiments in FIGS. 11-13. For example, a first program module (not shown) of the document navigator 58 may be configured to compute and store horizontal starting positions of various items in the first row of items (e.g., the row 94 in FIG. 12) in appropriate document display window. A second program module (not shown) may obtain the positional reference data from the first module and identify the corresponding item in the first row (e.g., the row 94 in FIG. 12) associated with each row of data to be displayed below the first row. This second program module may then display each row of data at appropriate horizontally indented locations below the first row. A third program module may keep track of the inputs received from the user (e.g., when the user clicks on the “More” button 99 or starts scrolling down the window 86 in FIG. 12) and initiate appropriate action (either by itself or through invocation of one or more other program modules) in response to the user's input. Additional program modules may also be provided to accomplish various other tasks contemplated by the designer of the document navigator 58 to accomplish the data display methodology discussed hereinbefore with reference to FIGS. 10-13.

Although the discussion given hereinabove has been primarily in reference to the display of hierarchical data sets, it is evident to one skilled in the art that a document navigator program may be devised to display non-hierarchical data according to the teachings of the present disclosure. For example, in one embodiment, such non-hierarchical data may include data related to various categories of vehicles (e.g., cars, trucks, airplanes, boats, etc.). The display of these categories of items may not have to follow any specific hierarchical order and, hence, the program designer may place these items in any desired order in the first row of display (e.g., similar to the row 94 in FIG. 12) followed by display of item-specific data at appropriate item-specific indented locations. Similar other non-hierarchical items and their related data may also be displayed in the manner discussed hereinbefore with reference to FIG. 10.

The foregoing describes a visual document navigation scheme in which items and their related data are displayed in a vertically aligned manner using horizontal indentations to visually link an item and its related data. A preferred document navigator software accomplishes such display methodology to facilitate accurate document viewing and efficient document navigation in a fast-paced, multi-tasking environment (e.g., a nurse or clinician on duty in a hospital). The use of vertically-aligned positional markers by the document navigator program to place an item and its related data at substantially the same horizontal starting location on an electronic display results in a display of a document's contents in a concise, logical, and focused manner. Elimination of irrelevant details or time-consuming “switching” among various screens of information significantly reduces clutter or distractions and improves user comprehension and retention of visual information, thereby improving the efficiency and accuracy of document viewing.

While the invention has been described in detail and with reference to specific embodiments thereof, it will be apparent to one skilled in the art that various changes and modifications can be made therein without departing from the spirit and scope of the invention. Thus, it is intended that the present invention cover the modifications and variations of the disclosed embodiments provided they come within the scope of the appended claims and their equivalents.

1. A method of electronic display, comprising:
displaying a plurality of items in a first row, wherein each of said items is displayed at an assigned position within said first row; and
displaying data related to at least some of said items in subsequent rows below said first row, wherein each respective subsequent row has a horizontal starting point substantially equal to a horizontal starting point of the position assigned to the item related to the data displayed in said respective subsequent row.

2. The method of claim 1 wherein said plurality of items includes a plurality of hierarchically-ordered items displayed in said first row in a descending order beginning with a hierarchically highest-order item positioned first in said first row.

3. The method of claim 2 further comprising:
displaying one or more bits of data related to a first item of said plurality of items in a second row below said first row; and
displaying one or more bits of data related to each hierarchically lower order item after said first item in respective subsequent rows displayed below said second row in a descending order starting with a display of one or more bits of data related to the item that immediately follows said first item in said plurality of hierarchically-ordered items.

4. The method of claim 1 further comprising displaying an item-specific indicium along with each of said plurality of items in said first row, said item-specific indicium also being displayed along with each item's respective subsequent row.

5. The method of claim 4 wherein said item-specific indicium includes an item-specific color, symbol, or both.

6. The method of claim 1 wherein said method is performed on a computer monitor.

7. An electronic display, comprising:
a first row displaying a plurality of items, wherein each of said items is displayed at an assigned space within said first row; and
one or more subsequent rows below said first row displaying data related to at least some of said items, wherein each respective subsequent row has a horizontal starting point substantially equal to a horizontal starting point of the space assigned to the item related to the data displayed in said respective subsequent row.

8. A data storage medium containing program code which, upon execution by a processor in a computing system, causes said processor to perform the steps of claim 1.

9. The data storage medium of claim 8 wherein said plurality of items includes a plurality of hierarchically-ordered items, and wherein said displaying said plurality of items includes:
displaying said plurality of hierarchically-ordered items in said first row in a descending order beginning with a hierarchically highest-order item positioned first in said first row.

10. The data storage medium of claim 9 wherein displaying data related to at least some of said items includes:
displaying data related to a first item of said plurality of items in a second row below said first row; and
displaying data related to each hierarchically lower order item after said first item in a separate item-specific row below said second row in a descending order starting with a display of data related to an item that immediately follows said first item of said plurality of hierarchically-ordered items.

11. The data storage medium of claim 8 wherein said program code, upon execution by a processor in a computing system, causes said processor to display an item-specific indicium along with each of said plurality of items in said first row, each item-specific indicium also being displayed in its respective item's subsequent row.

12. The medium of claim 11 wherein said item-specific indicium includes an item-specific color, symbol, or both.

13. A processor in a computing system, which, upon being programmed, is configured to perform the steps of claim 1.

14. The processor of claim 13 wherein said plurality of items includes a plurality of hierarchically-ordered items, and wherein said displaying said plurality of items includes:
displaying said plurality of hierarchically-ordered items in said first row in a descending order beginning with a hierarchically highest-order item positioned first in said first row.

15. The processor of claim 14 wherein displaying data related to at least some of said items includes:
displaying data related to a first item of said plurality of items in a second row below said first row; and
displaying data related to each hierarchically lower order item after said first item in a separate item-specific row below said second row in a descending order starting with a display of data related to an item that immediately follows said first item of said plurality of hierarchically-ordered items.

16. The processor of claim 13, wherein said computing system, upon being programmed, displays an item-specific indicium along with each of said plurality of items in said first row, each item-specific indicium also being displayed in one or more subsequent rows displaying data related to said item-specific indicium's respective item.

17. The processor of claim 16 wherein said item-specific indicium includes an item-specific color, symbol, or both.

18. A system, comprising:
a computing unit containing a processor configured to execute program code;
an electronic display operatively connected to said computing unit to display thereon information supplied thereto by said processor; and
a data storage medium operatively connected to said computing unit and containing program code, which, upon execution by said processor, causes said processor to perform the steps of claim 1.

19. The system of claim 18 wherein said plurality of items includes a plurality of hierarchically-ordered items, and wherein said displaying said plurality of items includes:
displaying said plurality of hierarchically-ordered items in said first row in a descending order beginning with a hierarchically highest-order item positioned first in said first row.

20. The system of claim 19 wherein displaying data related to at least some of said items includes:
displaying data related to a first item of said plurality of items in a second row below said first row; and
displaying data related to each hierarchically lower order item after said first item in a separate item-specific row below said second row and in a descending order starting with a display of data related to an item that immediately follows said first item of said plurality of hierarchically-ordered items.

21. The system of claim 18 wherein said program code, upon execution, also displays an item-specific indicium along with each of said plurality of items in said first row, each item-specific indicium also being displayed in one or more subsequent rows displaying data related to said item-specific indicium's respective item.

22. The system of claim 21 wherein said item-specific indicium includes an item-specific color, symbol, or both.

23. A document viewer to view an electronic document containing a plurality of items and related data on an electronic display, said viewer comprising:
means for assigning a display position to each of said plurality of items;
means for displaying said plurality of items in a first row, wherein each of said items in said first row is displayed at said display position assigned thereto; and
means for displaying data related to at least certain of said items in subsequent rows below said first row, wherein each of said subsequent rows contains data related to one of said items and has a horizontal starting point which is substantially the same as a horizontal starting point of the display position assigned to said one item.

24. A method, comprising:
receiving over a communication network an electronic document containing a plurality of items and related data from a site;
organizing the content of said electronic document to generate a revised electronic document therefrom; and
sending said revised electronic document to said site over said communication network, wherein said revised electronic document, when displayed on an electronic display at said site, contains the following:
said plurality of items displayed in a first row on said electronic display, wherein each of said items is displayed at an assigned position within said row, and
data related to at least certain of said items displayed in subsequent rows below said first row, wherein each of said subsequent rows contains data related to one of said items and has a horizontal starting point which is substantially the same as a horizontal starting point of the position assigned to said one item.

25. The method of claim 24 further comprising charging a fee for sending said revised electronic document.

26. The method of claim 24 wherein said communication network includes the Internet.

27. The method of claim 24 wherein said site is a remote site.

28. A system, comprising:
a client computer connected to a communication network, wherein said client computer is configured to transmit an electronic document containing a plurality of items and related data over said communication network; and
a host computer in communication with the client computer and connected to said communication network, wherein said host computer is configured to perform the following:
receive said electronic document from said client computer over said communication network;
organize the content of said electronic document to generate a revised electronic document, wherein said revised electronic document, when displayed on an electronic display of said client computer, contains the following:
said plurality of items displayed in a first row on said electronic display, wherein each of said items is displayed at an assigned position within said first row, and data related to at least certain of said items displayed in subsequent rows below said first row, wherein each of said subsequent rows contains data related to one of said items and has a horizontal starting point which is substantially the same as a horizontal starting point of the position assigned to said one item.; and
send said revised electronic document to said client computer over said communication network.

29. The system of claim 27 wherein said communication network comprises the Internet.
